(19) United States
(12) Patent Application Publication
(10) Pub. No.: US 2012/0317227 A1
(43) Pub. Date: Dec. 13, 2012

(54) INTERNET NEWS COMPENSATION SYSTEM

(76) Inventor: David S. Bettinger, Grosse Ille, MI (US)

(21) Appl. No.: 13/346,688

(22) Filed: Jan. 9, 2012

Related U.S. Application Data
(63) Continuation-in-part of application No. 10/967,560, filed on Oct. 18, 2004, now Pat. No. 8,095,467.
Application No. 10/967,560 is a continuation-in-part of application No. 09/504,657, filed on Feb. 14, 2000, now abandoned.

(51) Int. Cl. G06F 15/16

(52) U.S. Cl. 709/217

(57) ABSTRACT

A system for targeting an alert of a real-time news exposition to a geographically potentially interested group of viewer web terminals. The system includes a computer server to accept the real-time news exposition submitted by from a submitter web terminal, and further to track and meter the real-time news exposition chosen for display on viewer web terminals, and further to calculate compensation based upon at least one viewer exposure measure of the real-time news exposition, and further to communicate said compensation in real-time to the submitter web terminal. The system further comprises logic configured to receive an indication of a location of the submitter web terminal, compare the location of the submitter web terminal with viewer web terminals to determine the geographically potentially interested group of viewer web terminals, and transmit the real-time news exposition to the geographically potentially interested group of viewer web terminals.

### CROSS-REFERENCE TO RELATED APPLICATIONS

This application is a continuation-in-part of U.S. patent application Ser. No. 10/967,560, filed Oct. 18, 2004, which is a continuation-in-part of U.S. patent application Ser. No. 09/504,657, filed Feb. 14, 2000, both of which are incorporated herein by reference in their entireties.

### BACKGROUND

1. Field

An embodiment of the present invention is directed to operations in which a charge for e-commerce services is automatically and continuously determined and utilized for automated job performance and real-time accounting for the metering, calculation, and compensation of service time charges on internet servers for voluntarily offered contributions of news and information. A real time transaction output to contributors is a feature of the present invention. Such cost systems apply to automatic internet connected news and information sites and a variety of viewer interest sites.

2. Related Art

The display of news is common on the internet, as is the display of news and information to special interest groups. Internet web providers and host sites are common on the World Wide Web, hereafter referred to as the web or net. These sites display information and content that attracts viewers. A provider may self-fund a site but many advertisers pay the site provider that offers space for ads interspersed with provider content that is being displayed. It is common because of convenience for news publishers, whether on the web or other media, to rely on news consolidators for the collection and prioritization of news. For example, a small town newspaper's site may display national news from a wire service such as Associated Press, a news consolidator.

In the prior art of news publishing, the payment for a news item to an individual reporter was a matter of arbitrary judgment on the part of the publisher. In general, the structure of news media organizations has been a top down management and compensation structure. Salaried reporters are not on average well paid. Independent reporters such as paparazzi have been relegated to shadowing celebrities. An on-the-scene reporter who submits a report to a news wire service may find that report used by a network anchor earning far more than the reporter.

The web communicates breaking news stories in still, audio and video media. It can be argued that the depth and variety of web news as well as other news media has been narrowed by media company consolidations.

In the prior art of TV news programs, viewer surveys have been used as the basis for advertising time charges. Such surveys are not workable for judging the comparative value between breaking news stories for reporter compensation.

In the prior art on web commerce, advertisers have compensated a provider site based on the number of viewer visits to a site whether or not an advertisement was actually viewed. Also in the prior art of web commerce, advertisers have compensated a provider based on the number of referrals that routed the viewer to the advertiser's site from an ad banner. Duration of view has been addressed by some provider sites by stalling the download of requested data to the viewer so as to hold the viewer's attention for an advertiser. It may be inferred that this covert technique may elicit a premium from the advertiser for the site. Such tactics indicate the need for an improved cost system that ties ad revenue more closely to an adjacent item of viewer interest.

In the prior art of TV programs, videotapes are submitted and reported to a program such as “World's Funniest Videos.” Program personnel manually view all submissions and present the best for ranking by a studio audience in a prize competition. Such a process includes a plurality of reporters and compensation from a provider based on viewer ranking. But the process is too cumbersome for the timely presentation and compensation of live, breaking news, and offers no incentive for in-depth reporting.

In the prior art of television news, an auto accident item might be followed by an advertisement for the specific car involved. The business is not rule-based between news subject and product advertisement placement preferences.

In the prior an of e-commerce, numerous costing and pricing methods are known for pricing stock items including stock videotapes and clips. Such price competition is unsuitable for the unique and transitory items such as news and live, original reports.

Ginter, in U.S. Pat. No. 5,892,900, discloses an e-commerce system for validating documents by providing a distributed virtual distribution environment (VDE) that may enforce a secure chain of handling and control of electronically stored or disseminated information. Ginter relates to validated use of data documents, not live multi-casts. Ginter describes a fee for view received by the data provider that may or may not be shared with authors. Ginter's metering is better termed monitoring since no calculation of compensation is offered.

Shear, in U.S. Pat. No. 4,827,508, describes a database usage metering and protection system and method. Shear describes an annual fee as a pay-for-view for inert data documents. Shear provides no way of receiving new material from an author. Shear provides no method of compensating an author. Shear compensates only the publisher and the database supplier. Shear charges are based on monthly, annual, and usage which was the normal method of business transaction prior to Shear.

Reilly, et al., in U.S. Pat. No. 5,740,549, has disclosed an information and advertising distribution system and method that concerns recorded documents and recorded advertisements. Reilly delays the display of downloaded data, does not meter, and has no calculation mechanism.

Fuller, in U.S. Pat. No. 6,216,112, describes a software program that is downloaded by a single viewer for tracking the exposure of an embedded advertisement for advertiser billing when the program is run. Fuller tracks, meters, and bills but not for the document or data, much less a multi media exposition. Fuller provides compensation of the tracking software programmer(s) by advertisers based on usage after a variable delayed upload.

Dasan, in U.S. Pat. No. 5,761,662, discloses a personalized newspaper. Since a multitude of reporters is represented in a single download, no individual reporter can be singled out. Dasan ignores cost or compensation.

Cragen, in U.S. Pat. No. 5,973,683, describes a television download of multiple film ratings to censor viewer choice. The viewer pays-per-view for this recorded service. No compensation tracking, metering, calculation, or compensation concerns the author.

Krishnaswamy, et al., in U.S. Pat. No. 5,867,494 describes a method of integrated video conferencing over the internet that includes billing for the calls to the participants.

No compensation is made for the contributions of the participants.

### BRIEF SUMMARY

An embodiment of the present invention provides, briefly stated, an internet news compensation and cost system comprising at least one customized news repository server connected to the internet and accessed by a plurality of individual Web terminals for viewing news, information, advertising, and background in various media including text, voice, plural static images, streaming banners, 3-D images, animation, audio, continuous video and video packets whereby viewer interest is involved in the determination of reporter compensation for a submitted and contributed news or information item and exposition.

Embodiments of the present invention create an interactive feedback environment that communicates the financial benefit to a submitter of the exposure accrued to an exposition in real time during the exposition process.

In accordance with an aspect of the invention, a system for targeting an alert of a real-time news exposition to a geographically potentially interested group of viewer web terminals is provided. The system includes a computer server to accept the real-time news exposition submitted by from a submitter web terminal, and further to track and meter the real-time news exposition chosen for display on viewer web terminals, and further to calculate compensation based upon at least one viewer exposure measure of the real-time news exposition, and further to communicate said compensation in real-time to the submitter web terminal. The system further comprises logic configured to receive an indication of a location of the submitter web terminal, compare the location of the submitter web terminal with viewer web terminals to determine the geographically potentially interested group of viewer web terminals, and transmit the real-time news exposition to the geographically potentially interested group of viewer web terminals.

The foregoing and other aspects will become apparent from the following detailed description when considered in conjunction with the accompanying drawing figures.

### BRIEF DESCRIPTION OF THE DRAWINGS

FIG. 1 is a diagram of the relationship of the independent entities within an embodiment of the present invention.

FIG. 2 is a flow diagram of an embodiment of the current invention.

FIG. 3 is a schematic of the components of an embodiment of the current invention.

FIG. 4 is a flow diagram of the media and multi-media of an embodiment of the current invention.

FIG. 5 is a monetary data flow diagram of an embodiment of the current invention.

FIG. 6 is an example of a funding source preference list with funding source media items.

FIG. 7 is an instantaneous example of a metering and compensation calculation spreadsheet for an individual submitter.

FIG. 8 is an instantaneous example of a metering and billing calculation spreadsheet for a single funding source.

FIG. 9 is a flowchart of a method for targeting an alert of a real-time news exposition to a geographically potentially interested group of viewer web terminals according to an embodiment of the present invention.

### DETAILED DESCRIPTION

Reference will now be made in detail to exemplary embodiments of the present invention, examples of which are illustrated in the accompanying drawings. The exemplary embodiments are described below to explain the present invention by referring to the figures.

As used in the description of this application, the terms “a”, “an” and “the” may refer to one or more than one of an element (e.g., item or act). Similarly, a particular quantity of an element may be described or shown while the actual quantity of the element may differ. The terms “and” and “or” may be used in the conjunctive or disjunctive sense and will generally be understood to be equivalent to “and/or”. References to “an” or “one” embodiment are not necessarily all referring to the same embodiment. Elements from an embodiment may be combined with elements of another. No element used in the description of this application should be construed as critical or essential to the invention unless explicitly described as such. Further, when an element is described as “connected,” “coupled,” or otherwise linked to another element, it may be directly linked to the other element, or intervening elements may be present.

PROVIDER SITE: The specification describes an internet news compensation system that may be comprised of a provider site, a plurality of independent submitter web terminals, a plurality of viewer web terminals, funding source web terminals, associated site web terminals, and background data web terminals. The provider site may comprise four components, a submitter web server, a viewer web server, a metering mechanism, and a layout web server.

The submitter web server may be selected for accepting and indexing a plurality of multi-media expositions from a plurality of independent submitter web terminals selected for voluntary submission and continuous updating of the multi-media expositions by a plurality of independent submitters.

The selection of server hardware and data processing software for the provider site system may be made from a wide range of off-the-shelf products supplied by leading companies including IBM, HP, Apple, Oracle, SAP, Microsoft, and others. In operation the selected hardware and software in these internet server sites may operate three tier systems as intercessors between submitters and client viewers, handling multi-media expositions as objects, brokering objects between servers, using parallel processing for simultaneous presentation and internet hosting of multiple expositions, automatically updating multiple files, and dealing seamlessly with multiple data protocols. Further the modems, cables, ISPs, and internet system structure that are selected from these suppliers are readily available for continuously updated, electronic communication between sites, servers, and terminals in real time.

The multi-media expositions may be routed to a viewer web server selected for displaying the multi-media expositions on a provider site to a plurality of free agent viewers utilizing a plurality of viewer web terminals. As noted below, web terminals (including viewer web terminals and submitter web terminals) may include electronic devices capable of image capture, internet multi-media transmission, internet reception, and information display, including, smartphones.

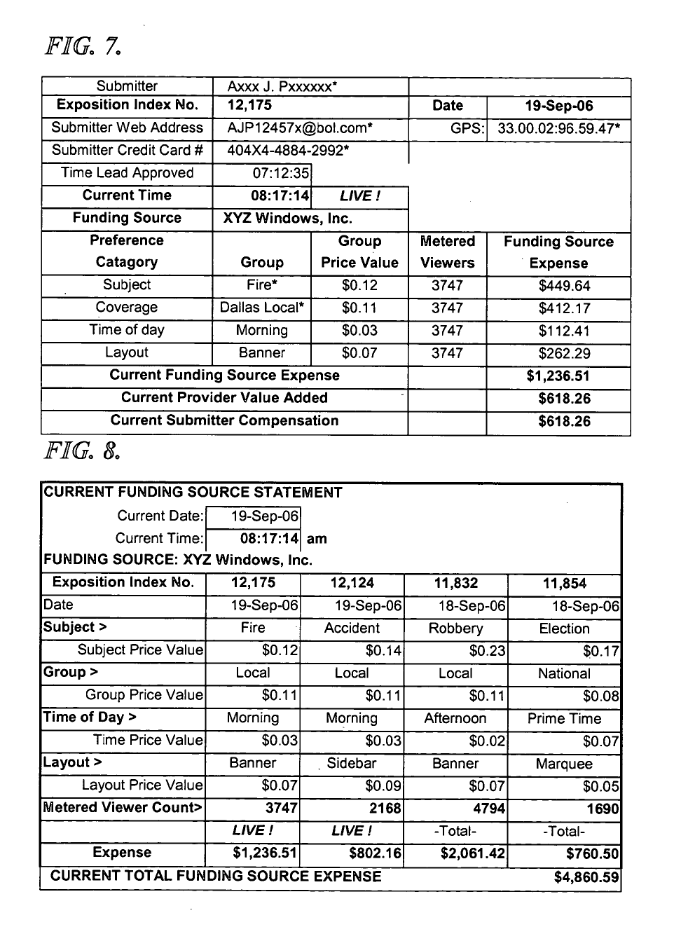

A metering mechanism may comprise means to track, meter, and calculate using computer hardware and software. For the purposes of the embodiments of the current invention the means to track a multi-media exposition as an object may be the exposition index number or numerical designator that is assigned to each individual exposition by the submitter web server. The exposition index number may be a data item inherent in a lead or a unique number sequentially assigned by the software. An example of a unique number for tracking is shown in FIG. 7. The data processing means to support tracking may reside in the product offerings of the aforementioned companies. Such an object broker software program may be selected for tracking each multi-media exposition chosen by the free agent viewers for display.

This tracking program may be coupled with means such as an accounting routine, algorithm, or program selected for calculating compensation accruing to each independent submitter based on at least one selected viewer exposure measure accruing to each of the submitted multi-media expositions. The means for calculating the compensation for a submitter may be at least one price value of a viewer exposure measure (PV) and at least one viewer count of the exposure of that viewer exposure measure due to the tracking of the exposition (C) multiplied together (PV×C) times the portion of this site provider gross income to be paid in compensation to the submitter (%). The compensation for a single viewer exposure measure and a single metered count of viewer exposure may equal Compensation=(%)×(PV×C). If more than one exposure measure applies to an exposition, then the calculation means may include the addition and sum of the multiplied amounts resulting in the following calculation for example

Compensation=(%)×[(PV₁×C₁)+(PV₂×C₂)+(PV₃×C₃)+etc].

The addition of the multiplied subtotals of each price value times each count for that viewer exposure measure is shown in FIG. 7 and discussed in the description of that figure. The accounting program coupled with means within the accounting routine, algorithm, or program may be selected for continuously updating the accrued compensation and communicating the updated accrued compensation to each submitter web terminal using the submitter web server. The means for updating the previous calculation may be inherent in the calculation since the metered count for each viewer exposure measure is cumulative.

Further, the submitter web server, the plurality of submitter web terminals, the viewer web server, and the metering mechanism may all be in continuous real time electronic communication among each other. The result of this real time communication may be that the compensation due each submitter is continuously communicated in real time to the submitter web terminal during the continuous communication of the multi-media exposition by the submitter web terminal. For example under current technology a camera-equipped cell-phone can be used by a submitter as a submitter web terminal to send a series of still pictures and a running monologue of an exposition. By switching the cell-phone display to text messaging the submitter can view the accumulated compensation earned by the submitter to this point in the exposition. Thus the submitter has an opportunity to judge the worth of continuing an exposition. Specifically, this principle of submitter control is illustrated in the breaking news embodiment.

MEASURES: The metering mechanism may calculate compensation based upon one or more viewer exposure measures. The surest measure of audience interest in a multicast may be the number of viewers that select a web site. Each one of these viewers after the teaching of the embodiments of the current invention may trigger a counter within the metering system of the server. This metering counts each new viewer as the elemental measure of viewer participation. Such viewer counts are usually referred to as “hits” upon a web site. There are a variety of other measures for awarding compensation to a submitter.

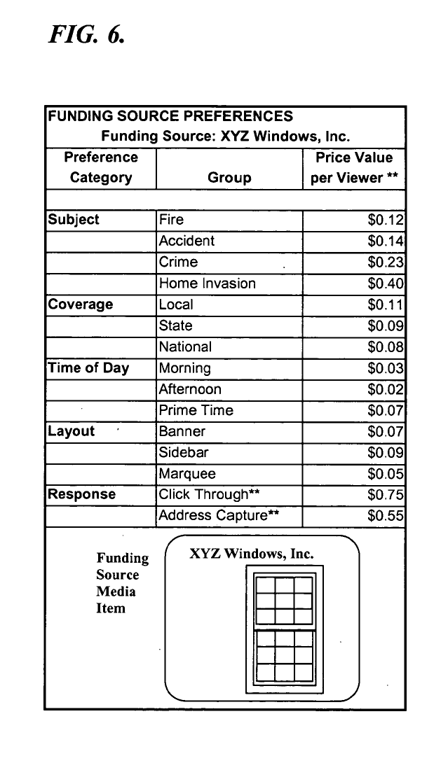

These viewer exposure measures may be chosen from the measure of the number of viewers, the measure of the duration of view of and by free agent viewer, the measure of free agent viewer response, the measure of free agent viewer click through to a linked site, and all possible measure combinations thereof. The number of viewers may be the cumulative metering count. The duration of view by a viewer of a multi-media exposition can be measured because the loss of a viewer results in the cessation of requests for multi-media packets. For example a condition for continuing provider site download to a viewer may be that the viewer must periodically strike the space bar of the viewer web terminal. Thus the beginning time of the download subtracted from either the current time or the time the provider site first omitted a periodic request signal represents the duration of view. Free agent viewer response may be the number of responses to an on-screen request or offering. For example, the site provider may offer a free premium or gift related to the exposition to elicit responses from viewers. Click-through to a linked site is a standard internet measure. For example, an advertiser may pay a site provider for hosting an advertisement and then pay an additional fee for viewers that click-through to the advertisers home site where the product may be ordered directly. Specifically, viewer measures are depicted by the instruction embodiment. Viewer measures are illustrated in FIG. 6 and explained in the detailed description of FIG. 6. The criteria for choice among the measures may be based upon the ability of the chosen software resident in the metering mechanism to meter a particular measure and the inclusion of that measure in the preference list of the funding source.

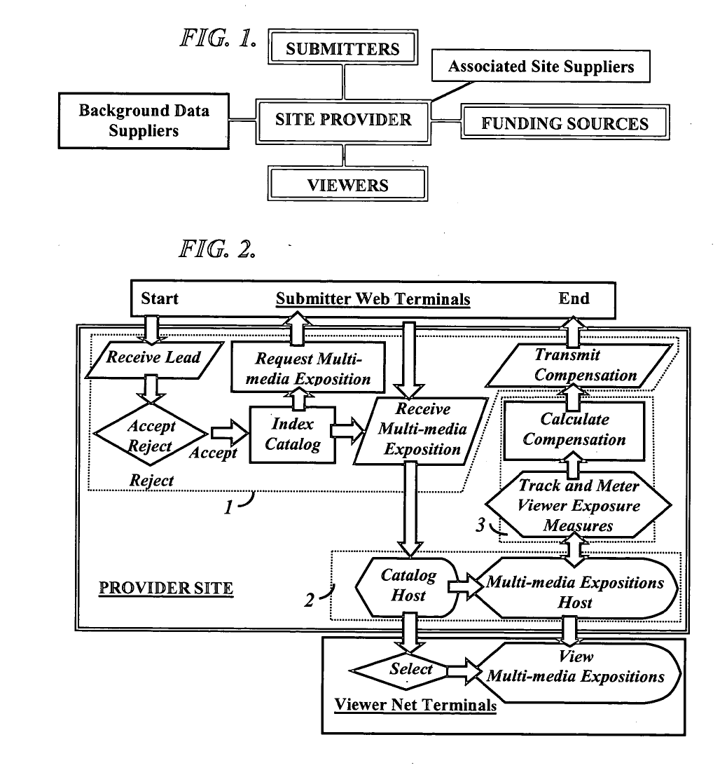

PROMOTION: With the enormous volume of material available on the internet it could be impossible for a single exposition to gain any sizeable audience on its own within a short period of time without promotion. The embodiments of the current invention may use associated sites to promote expositions. Associated sites may be internet sites that are likely to have the same viewer audience as may be associated with the characteristics of the exposition. Thus the web server may be further selected for real time communication with associated internet sites of viewing availability of at least one of the multi-media expositions. The relationship of associated site suppliers to the site provider is shown in FIG. 1 and detailed in the description of that figure. An example of an associated site is described in the first scheduled embodiment concerning an exercise instructor. The process of promotion is illustrated in the technical symposium embodiment.

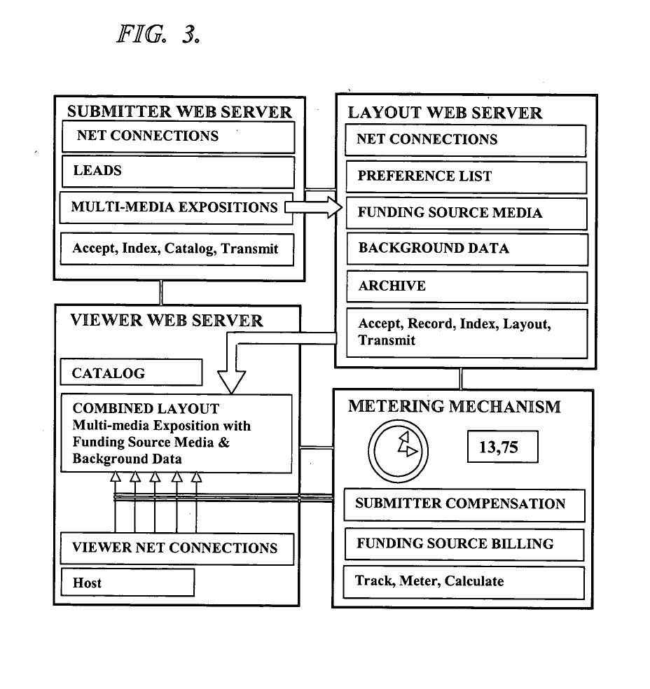

LEAD: Not all submitters may have an exposition that fits the audience of a provider site. Thus there may be a need for a collection of data to provide support for acceptance by either a software or human gatekeeper at the provider site. Thus the submitter web server may be further selected for accepting and indexing each multi-media exposition based upon a lead of each multi-media exposition. Specifically, the lead is illustrated in the breaking news embodiment and the instruction embodiment. The examples of the elements of a lead are shown in FIG. 7 and detailed in the description of that figure. The relationship to other components of the current invention are shown and described in FIGS. 2 and 3.

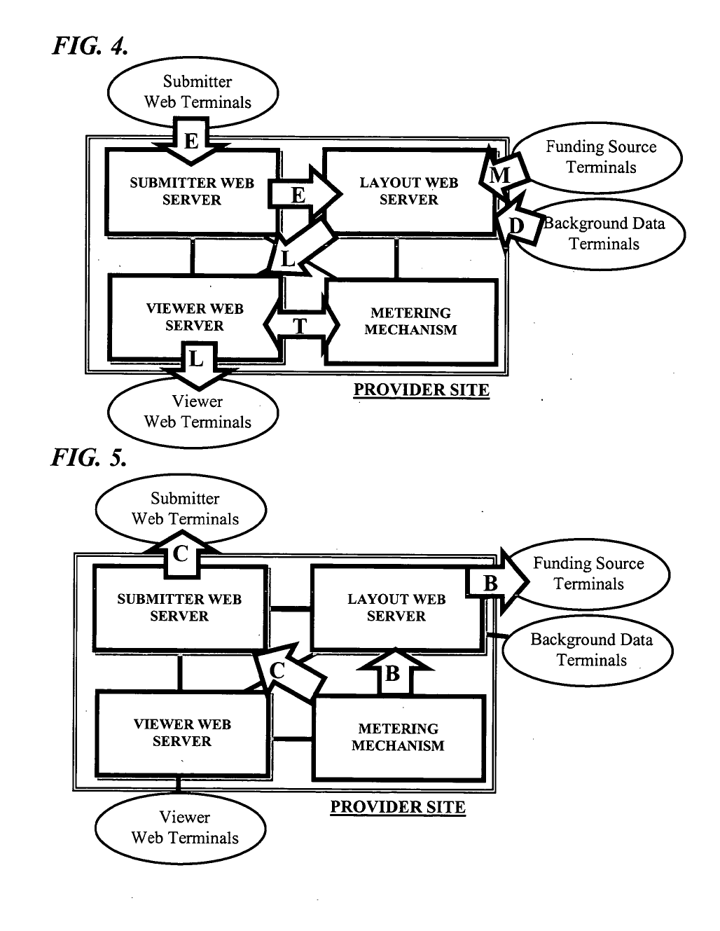

LAYOUT WEB SERVER: Compensation may indicate a minimum need for the site provider to recover expenses. This implies that expense recovery can be gained from some element of society that would seek to have a message attached to an exposition. A web server may be needed that can receive, accept, record, index, layout, and transmit these messages and funding source media. Thus the provider site may further comprise the addition of a layout web server selected for accepting and indexing a plurality of funding source media items from a plurality of funding source web terminals. Specifically, the layout web server is discussed in the instruction embodiment. Elements of the layout web server are shown in FIG. 7 and detailed in the description of that figure. The relationship of the layout web server to other components of the embodiments of the current invention are shown in FIGS. 4 and 5 and described in the detailed description of those figures.

ARCHIVE: To ensure a chronicle for business purposes the indexed multi-media expositions may be recorded, saved, and stored in an archive. The storage volume required to store all expositions may be considerable and a filter may be used to limit the degree or selection of exposition storage. This storage of a multitude of previously indexed digital multi-media may best be accomplished by a database software that treats each exposition as an discrete object for internal program sequencing and retrieval. Since the indexing of multimedia expositions may take place by the submitter web server and the layout web server may manipulate the exposition in order to layout the final product for the viewer, then it follows that the logical place for this archive to reside may be in the layout web server. Thus the layout web server may further be selected for accepting and recording multi-media expositions in an archive. This is illustrated in FIG. 3 and explained in the detailed description of FIG. 3. Specifically, the archive and its use are illustrated in the instruction embodiment.

LEAD CATALOG: The internet offers an entire universe of choice which may make it difficult for a viewer to choose one exposition from many even on the same provider site. A catalog of the expositions that are currently live and available on the provider site may be desirable. Thus the submitter web server may further be selected to identify, interpret, sort, rank, and segregate the individual multi-media expositions into groups within a catalog, based upon preselected criteria applied to the lead. An example of preselected criteria may be similarity of subject. Further, the viewer web server may be selected for displaying the multi-media exposition groups and the multi-media exposition catalog on an internet site to a plurality of free agent viewers. This is illustrated in FIGS. 2 and 3 and explained in the detailed descriptions of FIGS. 2 and 3. Specifically, the catalog and its use are illustrated in the literary and performance embodiments. The formation of a catalog may include the automatic accumulation and storage of past viewer preferences in order to prioritize breaking news items. The lead for a news item may be received in the form of audio voice requiring computer voice recognition and language translation in order to register the news item to the correct catalog group.

BACKGROUND DATA: When dealing with breaking news that may affect large segments of society, the perspective provided by background information may be desirable. For example, the community warning embodiment can be made more meaningful to those concerned for the safety of others by the display of a map showing the location of a dangerous situation downloaded from a site that supplies maps such as www.mapquest.com. Thus the layout web server may be further selected for retrieving, accepting and indexing a plurality of background media items from a plurality of web servers and terminals. Embedded links to background-data sites that are provided either automatically or based on viewer selection are common in the industry. This is illustrated in FIG. 3 and explained in the detailed description of FIG. 3. Specifically, background data, source, and use are illustrated in the breaking news embodiment.

PREFERENCE LIST: Funding sources such as advertisers may have no way of predicting the exact placement of their media, just as site providers may be faced with a new mix of expositions each day. However, the funding sources may develop guidelines or preferences for the use of their media. This guidance to the site provider may be provided to the layout web server. The site provider may host the layout web server to receive these preference lists from the funding source web terminals. Thus the layout web server may be further selected for accepting and indexing each funding source media item based upon a preference list of each funding source media item. Specifically, preference lists are illustrated by the breaking news embodiment and the literary embodiment. However, preference lists are well detailed in FIG. 6 and explained in the detailed description of FIG. 6.

CATALOG USED FOR LAYOUT: The best advertising may use the juxtaposition of advertisements with associated subjects or media to reinforce the advertiser's desired message. This rule may also be true for all forms of message promulgation by funding sources whether for profit or not. Thus the layout web server may further be selected to position each funding source media item in close proximity to the multi-media expositions of a related catalog group based upon the preference list of each funding source media item. This is illustrated in FIG. 3 and explained in the detailed description of FIG. 3. Specifically, the use of a catalog for layout by the layout server is illustrated in the exercise embodiment.

PRICE VALUE: Without specific incentives placed upon the site provider, the funding source may have little or no restraints on the use of the funding source media. By placing a price value on each item on the preference list, the funding source may provide an incentive to the site provider to use the funding source media in the most profitable manner. Thus the preference list may further comprise price value of each preference item. Price value and its use is well illustrated in FIG. 6 and explained in the detailed description of FIG. 6. Specifically, price value is illustrated in the instruction and literary embodiments.

BILLING CALCULATION: The financial base for embodiments and business models of the current invention may be the funding source. The funding source may provide the monetary support to pay the site provider based upon a continuing agreement with the site provider. The funding source may be an individual, product advertiser, industrial firm, institution, governmental department or an agency of one of the aforementioned entities. The funding source may, in some cases, also be the site provider.

Continuing agreements between funding sources and site providers are typical in the internet industry. For example, in current practice an advertiser will pay a site provider based on the count of the number of viewers to a particular web page where the advertiser's advertisement is displayed on the same web page with exposition material that is the primary attraction of the viewer. The price value of each viewer may be dependent upon the ability of the exposition material to attract a viewer that is compatible and beneficial to the goal of the advertiser. Some of the factors that may affect the ability of the exposition material to attract compatible and beneficial viewers may include subject, timeliness, presentation, action portrayal, time of day, and size of advertisement. These factors are also common in current advertising practice. Some agreements between advertisers and site providers may also include additional payments to the provider for estimated duration of view. Without periodic response from the viewer the transmission of an exposition ceases providing an end point to the metering of duration. Some agreements between advertisers and site providers include incidental payments to the site provider for each viewer that “clicks through” from the provider page to an advertiser site or responds to a displayed animation, question, or offer. Some agreements between advertisers and site providers include incidental payments for each viewer's email address captured due to a displayed advertisement. Thus it is common in the internet industry for the funding source to pay the site provider based on viewer count times estimated average duration of view times the price value per viewer plus incidental provisions. Thus the following formula represents a simplification of the gross income to the site provider which may also be the billable expense to the funding source.

Site Provider Gross Income=Viewer Exposure Measure×Price Value/per Viewer

Thus the means selected to calculate expense accruing to each funding source may be further based on at least one selected price value and at least one viewer exposure measure mathematically manipulated within a computer accounting program. The calculation of a funding source bill is illustrated in FIG. 8 and explained in the detailed description of FIG. 8. In addition, the calculation is also illustrated in the breaking news embodiment.

COMPENSATION CALCULATION: It may be an outcome from the teaching of the embodiments of the current invention that it is difficult for a site provider to estimate the attraction of viewers to a particular news item before the exposition. The site provider can eliminate this uncertainty by an open offer to all reporters to income share. Thus the compensation to a reporter may become a percentage of the gross income generated to the site provider for the reporter's individual exposition item.

Reporter Compensation=Provider Gross Income×Provider Pay-out Percentage

Thus the means selected to calculate compensation accruing to each independent submitter may further be based upon a portion of the sum of expenses accruing to the funding sources for the exposition of the independent submitter mathematically manipulated within a computer accounting program. Submitter compensation is illustrated in FIG. 7 and explained in the detailed description of FIG. 7. Submitter compensation is illustrated in all the embodiments described below.

UNSCHEDULED: Breaking news knows no schedule. Its chief characteristic and attraction is that it is immediate. The immediacy has a profound impact on the site provider. The embodiments of the current invention teach that the provider site must be prepared for instant acceptance of a worthy exposition from a previously unknown submitter or reporter. Thus beginning of the exposition submission by the submitter is unscheduled by site provider. The process that makes unscheduled responsiveness possible is shown in FIG. 2 and described in the detailed description of FIG. 2.

Unscheduled expositions are illustrated in the breaking news and community warning embodiments below.

LOCATION: Viewer and exposition location may be utilized by embodiments of the present invention to target an alert of an exposition to a geographically potentially interested group of viewer web terminals. For example, the exposition may be a real-time news exposition local to certain viewer web terminals. Alternatively, the exposition may be local shopping leads. In the case of a cell phone submitter web terminal and a cell phone viewer web terminal, location may be determined using built-in Global Positioning System (GPS) capabilities of the cell phones. Alternatively, tower triangulation may be used to determine viewer and submitter (i.e., exposition location). It should be noted at this point that the location of the submitter and the exhibition are discussed herein as being approximately the same. However, the invention is not so limited. In an alternative embodiment, the submitter and exhibition locations may differ. Viewers' locations may be used to present multi-media expositions to select viewers based on exposition location and viewer location. In the case of a cell phone viewer web terminal, a location identified with an exposition may be compared with a location of the cell phone viewer web terminal to determine if the location identified with the exposition and the location of the cell phone viewer are, e.g., geographically related. For example, if the location identified with the multi-media exposition is within 50 miles of the location of the cell phone viewer web terminal, an alert may be transmitted to that cell phone web terminal. It will be appreciated that the exact distance from exposition and the viewer can be any appropriately predetermined distance.

Alternatively to using the viewer's location, a viewer may input one or more locations that are of interest to them (i.e., preferred locations). A location identified with an exposition may be compared with the preferred locations to determine if the location identified with the exposition is, e.g., geographically related to one or more of the preferred locations.

PRIORITY: Expositions may be assigned a priority level. For example, a breaking news exposition involving national security may be assigned a high priority, while a breaking news exposition involving local politics may receive a normal or low priority. Expositions may be assigned priority levels using any appropriate priority ranking approach. The priority level may be assigned using the submitter web terminal. Alternatively, the provider site may assign the priority level. Alternatively, the priority level may be suggested using the submitter web terminal and assigned by the provider site. The priority level may be formed based of, e.g., lead information such as key words in a lead (e.g., fire). Keywords may be transmitted as text with the exposition or alternatively may be formed from recorded audio. In this way, the site provider may serve as a gatekeeper. The gatekeeper may also consider reporter (submitter) history.

Priority levels of expositions may be used to present expositions (or alerts of expositions) to select viewers based on exposition priority level and viewer selected priority level preferences. In the case of a cell phone viewer web terminal, a viewer may have set preferences to receive instant alerts for all expositions of a high priority. Accordingly, in an embodiment that identifies a geographically potentially interested group of viewer web terminals and that considers priority levels, that viewer web terminal may not receive an alert if the exposition does not have a high-enough priority level. Other viewers may set their priority levels differently.

### Unscheduled Example 1

### Breaking News Embodiment

In an embodiment of the present invention an internet site provider may make available to the general public a web news site that offers breaking news stories much as a television news magazine. Such a news provider site specializes in fires, accidents, celebrity events, political events, environmental, and weather reports. The reporters that submit breaking news stories to this site are independent agents that have suitable equipment for generation and communication to an internet portal of media such as text, voice, audio, digital photos, drawings, and video. The sole advantage of a reporter may be that no other potential reporter is present at a particular location where news is breaking and the need for a live on-site reporter is urgent to support the public's instant need to know.

For the purposes of embodiments of the present invention a reporter may be the individual that initiates the contact to the provider site and therefore may have a vested financial interest in the compensation earned by the exposition. The reporter may be the individual that communicates the existence of the potential for the exposition to the site provider and may monitor the arrival of the compensation figures to gage either the growth or decline of audience interest for the exposition. The reporter may present a live audio or video report in real time to the web site provider as a continuing exposition of the news event in progress.

For the purposes of embodiments of the present invention, the term “real time” may be defined to mean the apparent continuous communication between two pieces of electronic equipment despite generally invisible delays due to source spooling, packet segmentation, packet sending, transmission queuing, reception storage, reception re-sequencing and other electronic data processes.

For the purposes of embodiments of the present invention an exposition may be a live, original, news item, report, feature, discussion, lesson, instruction, demonstration, review, infomercial, feature, performance, or presentation offered and transmitted to a provider site for compensation. The exposition may or may not involve the submitter as a participant in the exposition. An exposition may be preformed by a single participant or multiple participants just as a sporting event may have multiple reporters participating in the play by play coverage together. The equipment operating expense of a single channel or page to the site provider may be minimal. Thus the cessation of the exposition may be left to the reporter to judge either that further exposition is profitable or unprofitable based on the cumulative compensation transmitted to the reporter by the site provider.

The viewers may be free agents, media consumers, who have selected this site to view the latest breaking news stories. As flee agents the selection by viewers of a particular news story and the branching to that news item on the site is made based upon their personal criteria and preferences. The incoming news item may be augmented by the site provider in numerous ways including translation of the reporter's words, use of a virtual synthetic news anchor for introduction, addition of file footage and addition of background information. In embodiments of the present invention the service site may be offered free to viewers because the monetary source may be advertisers that pay fees to the provider much as advertisers fund a television news report. Thus the funding source for this embodiment may be an advertiser of replacement windows that is billed for both submitter compensation and value added services by the site provider. These value added services may comprise administration, hosting, layout, and billing services by the site provider. The funding source media may be an advertisement with a picture of a window and the company name. The procedure may be that advertisements are submitted to the site provider for view on the provider site and are positioned adjacent to and on the same screen, page, channel, or subsidiary site and page as appropriate breaking news stories. The reporters may be compensated for their contributions to the site based on the exposure generated based on measures comprising viewer hits, viewer downloads, viewer duration, viewer responses, time of day, type of media, subject matter, and other measures. The advertisers may be charged, in kind, a higher rate to cover both reporter compensation and provider fees based on equivalent viewer measures. Thus the advertisers may be the monetary source for this business model. The difference between the compensation to the reporters and the fees paid by the advertisers may be gross income for the provider. Thus an equitable and beneficial result may be created for all parties due to the attributes of the embodiments of the present invention.

REPORTER SPECIFIC: Thus the submitter may comprise a reporter, further the multi-media exposition is an unscheduled news and information report,

further site provider may comprise a news collection and dissemination agency,

further provider site comprises a news and information internet site controlled and operated by the provider,

further the lead may comprise subject, identity, location, and payment account,

further funding source may comprise an advertising agency,

further the funding source media item may comprise an advertisement,

further the metering mechanism may comprise at least one means chosen from means to measure number of viewers, means selected to determine time of day of news and information report downloaded from the provider site by the viewers and means selected to determine time of day of the duration of view of the news and information report downloaded from the provider site by the viewers, whereby the metering mechanism calculation means selected for utilization of the measurements and determinations to provide for compensation determination for the reporters,

wherein the criteria for choice among the means may be based upon the ability of the chosen software resident in the metering mechanism to meter a particular measure and the inclusion of that measure in the preference list of the funding source, further whereby the metering mechanism may be selected for communication of the compensation to the reporters as the reporters continue submission of the news and information reports.

### Unscheduled Example 2

### Community Warning Embodiment

In another embodiment a site provider specializes in highway and traffic issues. The site provider may provide a large number of simultaneous multicast channels after the teaching of an embodiment of this current invention that display real time highway activity as contributed by individual submitters acting as good citizens to uphold the public good as well as acting as reporters. The funding sources may be various groups against drunk drivers, automobile insurance companies, and the State Highway Patrol that also monitors the site. The site may be profitable to the provider and a short easy-access code for potential reporters may be widely advertised.

For example a submitter to this site may be a housewife returning from shopping when she observes a driver recklessly enter a busy highway from a drinking establishment. As the reckless driving continues she may use her cell-phone to dial the easy-access code to initiate communication with the site provider to report the driver while at the same time becoming an on-site reporter. Her cell phone number may be sufficient for identification and the phone may automatically furnish the GPS location. Her cell phone account may be sufficient financial account identification and may be credited with any compensation due. Thus, the necessary elements of a lead may be automatically established with no human response required from the site provider. The process flow that supports this automatic acceptance is shown in FIG. 2. After the lead is established she may receive from the provider site a verbal acceptance message and a tone signal as an indication of approval of her exposition or report multicast. The provider site may index her report by assigning it a unique index number and enters it in a catalog that is posted to a web page of the provider site. As she begins her exposition commentary, she may place the cell phone on the dashboard of her car with the camera facing forward and follow the erratic driver at a safe distance. Thus real-time broadband of the errant driver is initiated for multicast.

Many viewers may have their internet browsers set to alert them as to the presence of such a situation being multicast from this provider site catalog. Other viewers may limit their alert to only traffic situations in their local area. As the route followed by the reckless driver takes the reporter further from her home, her tendency to discontinue the pursuit may be overcome by monetary incentive. The display on the back of the cell phone may provide a real-time readout of the monetary result of the number of viewers that have joined the multicast. The number of viewers may be continuously tallied and factored into the continuously updated calculation of compensation by the site provider. Soon sufficient cumulative income to her account may be generated to pay for her current purchases. As the reckless driver is apprehended by the Highway Patrol it is in their certain knowledge that the action is warranted by the record of the multicast and a large number of remote witnesses. The housewife may feel satisfaction from having prevented a possible accident resulting in the injury or death of an innocent person by the erratic driver and the validation that monetary reward brings.

Numerous other traffic reporters may provide expositions to sites for the same or allied providers. The summary of these reports may be used for essential driver information. For example the GPS location of a variety of individually reported traffic dangers and tie-ups may be filtered and communicated to a driver information and communication system to inform each subscription driver of hazards local to their planned route.

### Unscheduled Example 3

### Local Breaking News Alerts Embodiment

In an embodiment of the present invention a provider site may make available to cell phone users in a carrier's network breaking news alerts. Alternatively, the carrier itself may serve as the provider site (or site provider) as that term is used herein. The reporters that submit breaking news stories to the provider site may be independent agents that have suitable equipment for generation of expositions and communication thereof to the provider site. For example, a reporter (or submitter) may user their cell phone capabilities to record a video of a building collapse, or in another example a flash flood, and to upload that video (or exposition) in real time to the provider site.

When the exposition is uploaded to provider site, the location of the exposition may be determined. For example, the reporter's cell phone may include built in GPS capabilities and that reporter's location may be uploaded with the exposition to the provider site.

When the exposition is uploaded to the provider site, a priority level may be assigned a priority level. In this example, expositions may be assigned a rank from 1 to 5 with 1 being very high priority, 2 being high priority, 3 being average priority, 4 being low priority, and 5 being very low priority. The priority level may be assigned based on the lead of the exposition. In an alternative embodiment, a submitter web terminal may call in a report of, for example, the flash flood. The submitter's multimedia exposition (their audible call) may be converted to text and the text key words may be used to determine priority level.

The provider site may have access to location information for cell phone users (viewer web terminals) in a carrier's network. Cell phone users (or viewers) that are within a predetermined geographic distance from the location of the exposition may be identified as geographically interested viewers. In one embodiment, all geographically interested viewers may then receive (via their cell phones) an alert regarding the breaking news item (exposition). In the alternative embodiment using a called in report, the certain keywords (e.g., flashflood) may generate a highest priority 1 alert for viewers within, e.g., 25 miles.

Priority preferences of the geographically interested viewers may be considered before transmitting the exposition (or alert). For example, a viewer may have set their viewer web terminal to receive alerts only of high or very high priority expositions. Accordingly, even if a viewer is identified as geographically potentially interested in the news exposition, they may not receive an alert thereof if the news exposition is of an average priority or lower.

In an alternative embodiment, alerts of a certain high level (e.g., very high priority) may cause a viewer web terminal that is in a sleep mode to awake and communicate the alert.

Certain geographically interested viewers that receive alerts may then request to view the exposition. In this embodiment, expositions may be offered free, at least during their initial real-time occurrence, to viewers because the monetary source is the carrier who pays fees so as to offer a service that distinguishes that carrier from other carriers. Thus, the funding source for this embodiment may be the carrier. Additionally or alternatively, advertisers may also form at least part of the funding source. Those certain geographically interested viewers that view the exposition may be tracked so that compensation may be paid to the reporter in accordance with the various embodiments discussed herein. In the alternative embodiment with the called in report, clicking on the report to get more information may be considered a view.

In an embodiment, compensation may be directly credited by the carrier to the reporter (submitter) phone account thereby ensuring secure deposit.

An exposition may not be viewed later (not in real time) in an embodiment. However, in an alternative embodiment, the exposition may be viewed later (not in real-time) for a fee. In still another embodiment, the exposition may be presented in real-time without advertising, but later (not in real-time) with advertising.

In alternative embodiment, sending of an alert to geographically potentially interested viewer web terminals may include sending at least one of a text message (SMS or MMS), an email message, an instant message (via, e.g., chat), a social media communication, and the like.

In another embodiment, alerts may also be transmitted to contacts of each member of the geographically potentially interested group of viewer web terminals. This would enable a friends and community alert embodiment. Contacts may be defined, e.g., as listed contacts in a viewer web terminal, frequent contacts in a viewer web terminal, or the like.

SCHEDULED: Beyond breaking news, some activities of human experience and interest draw a larger audience if scheduled. For the submitter and the site provider a larger audience may mean a large compensation and income. Thus a teaching of an embodiment of the present invention may be that it is efficient and beneficial for the beginning of the exposition submission by the submitter to be scheduled at a day and time mutually preselected by the submitter and the site provider.

### Scheduled Example 1

### Instruction Embodiment

In a further embodiment of the current invention, a site provider may have registered a provider site with a unique domain name that emphasizes that the provider site specializes in the production and presentation of fitness related expositions. The fully computerized provider site may be capable of hosting numerous multi-media expositions at the same time. In this embodiment the submitter may be an exercise instructor. The exercise instructor may desire to use a fitness site to distribute an exposition of a live, teaching demonstration and exercise feature to a multitude of viewers. Previous to the multicast the instructor may have contacted the site and the site provider may have scheduled a multicast of the exposition at a given time on a specific day of the week for 24 weeks.

As shown in FIG. 2, for example, the provider site may be generally automated in terms of its multicast and accounting functions. This automation may be an indication that although occupying an important middleman position between the reporter and viewers, the markup upon the original material provided by the submitter may be substantially lower than charged by other reporting venues such as television, newspapers, or magazines. These other venues may have higher costs of distribution of their information. For example, the income of reporters, editors, and writers for a major news-magazine may be less than ten percent of the publisher's gross income. The same measure applied to the business structure of the current invention may find that the reporter's compensation may be approximately one half of the provider's gross income for the reporter's exposition. The effect of this low markup may be likely to create a multitude of internet venue sites for many interest groups.

Arrangements for scheduled multicasting facilities may be based on the initial contact of the site by the exercise instructor in the form of a lead. An embodiment teaches that this initial offer by way of a lead by the submitter and this acceptance by the provider site may be a necessary and integral step in the compensation process. The exercise instructor may be requested by the producer site to stipulate in the lead that the material to be multicast is original and free of encumbrances such as trademarks or copyrighted material owned by others and that the material to be broadcast is free from fraudulent content. The general subject or headline of the exposition, commentary, instruction class, or editorial may be submitted by the exercise instructor to the provider site. The site provider may assign the exposition a scheduled time. Regular multicasts on a daily or weekly basis may be scheduled. The exercise instructor also may communicate to the web site a credit number for deposit of compensation to the instructor's account by the site provider. The teaching of an embodiment is that the deposit of actual monetary funds for an exposition can be carried out in real time due to the continuously updated nature of the compensation. Since the exercise instructor terminal may be continuously updated, then the continuously updated of a credit account need not be delayed, but may be automatically deposited as well. Other deposit of actual fund arrangements may include deposit at the end of the multicast or at regular periods such as weekly or monthly. It is likely that the site provider would delay actual payment of compensation to the reporter until the site provider had been paid by an advertiser, other monetary supporter, or funding source.

The web site may promote the show by previews and ads on related associated sites as being available at a specific time each day. At the appointed time the instructor may initiate the connection to the provider site and begin a number of exercise routines. The funding source may have transmitted an advertisement to the layout web server that then may combine the advertisement with the exercise exposition. As the instructor begins with a monologue describing the preselected set of routines for the day, a faithful cadre of viewers may activate their viewer web terminal monitors and begins to view the multicast on the provider site.

This initial viewer group may be counted by the metering mechanism and a continuous cumulative sum of earnings may be calculated and sent to the receiving monitor at the instructor's initiating web terminal. Since exercise enthusiasts may be a substantial and growing segment of the population, many providers of goods and services to this segment may be eager to have their wares promulgated to this audience. The communication of an exercise routine may require a substantial portion of the screen for the viewer to enjoy, emulate, and perhaps participate. Since the viewer's screen may be somewhat rationed in terms of area available for advertisements, the value for access to this audience may be high, and thus the amount charged to the advertisers may be high. Correspondingly, the compensation per viewer to the instructor may be high. The calculation may include allowance for the number of viewers, the duration of view, the time of day, the value of the media, the scarcity of the screen billboard space, allowance for multiple participants within a single presentation, and multiple sites within a single presentation. Multiple sites involved in a single exposition would present additional coordination efforts for the site provider and may raise the portion of gross income from the funding source retained by the provider.

As the exercise routine continues, other interested but late viewers may come onto the site and join the view while others may drop out to handle local distractions such as phone calls or instant messaging. Still the continuous and cumulative calculation of the number of hits on the site may be used to generate and communicate to the instructor the cumulative earnings of the multicast. This communication of compensation may provide an incentive to the instructor to continue the broadcast. If some superior exercise instructor lures away the viewers, the instructor may be informed because the accrued compensation displayed by the submitter web terminal may have ceased to increase. The instructor then may cease to submit the exposition, thus saving time and effort. On the other hand, a large number of viewers may be reflected in a growing cumulative compensation that may provide an incentive to the instructor to continue with the exposition.

As the exposition continues the layout web server may record the exposition and stores it in an archive. This archive may then be available for later combination with subsequent expositions from the same instructor and sale as edited exercise video to the mutual profit of both site provider and exercise instructor.

The site provider on behalf of the submitter may offer to viewers an internet e-mail address for responses and questions during the exposition. Further, some viewers may choose to implement a duplex internet connection with the provider site. These duplex connections may include text messages, audio, or real time video from the viewer to the site. In this embodiment of the present invention this duplex video may show the viewer following the exercise routine, or performing the routine with a misunderstanding of the technique to be performed. These duplex videos may be combined into a viewer matrix and sent by the site as feedback to the reporter's monitor for active, real time appraisal of the quality and responsiveness of the viewer audience. Individual viewer errors of performance may be remedied by the instructor. Since not all viewers may be counseled individually within a real time multicast, an incentive may be created for early site sign-on by viewers vying for such duplex connections.

Between routines the exercise instructor may pause to ask for questions and responses from the multicast audience. Some responses may be by email, others responses may be made to the provider site and relayed to the instructor. The responses through the site may be more valuable to the instructor. Such direct provider site responses tallied by the metering mechanism may be given a high price value by the funding source. The active participation of the viewers may be likely to provide more opportunity to be influenced by the advertising material. Thus viewer response would provide additional income from funding sources and advertisers. With prior arrangement between the site and the instructor, mention may be made of the advertiser's product within the presentation of the reporting feature. For example the exercise instructor may provide a positive mention of a personal heart rate monitor or printed instruction manual. Such a mention might merit an additional preference item and a greater compensation per hit during that segment of the exposition, presentation, or feature as this additional cost may be passed on to the advertiser who has agreed to these terms beforehand. It is also possible that the low overhead of the site provider may create an understanding by advertisers that the nominal charges for additional items such as product mentions are reasonable and justifiable based on common published industry price values.

If the exercise instructor is well known, the exposition may be of particular value. If the particular routines or moves by the exercise instructor are known in advance to have particular value, then the provider may charge admission to the multicast. Such a monetary fee charged a viewer may assure funding sources that the prospective viewer audience has a high level of commitment. A method of assuring premier viewers may involve the registration of the viewer for direct contact by a funding source. For example a marketer of exercise material or services would benefit from having viewers register to view a special exercise exposition by a nationally respected instructor.

SCHEDULED: Thus the submitter may comprise an exercise instructor,

further multi-media exposition may be a scheduled exercise instruction class,

further provider may comprise a health and fitness site provider,

further provider site may comprise a fitness internet site controlled and operated by the health and fitness site provider,

further the lead may comprise subject, identity, location, and payment account,

further the exercise instructor may be scheduled to begin the exercise instruction class at a specific date and time based upon an agreement with the health and fitness site provider,

further the funding source may comprise a manufacturer of exercise equipment,

further the funding source media may comprise an exercise equipment advertisement,

further the metering mechanism may comprise at least one means chosen from means to measure number of viewers, means selected to determine time of day of health news and information report downloaded from the provider site by the viewers and means selected to determine time of day of the duration of view of the news and information report downloaded from the provider site by the viewers, whereby the metering mechanism calculation means selected for utilization of the measurements and determinations to provide for compensation determination for the exercise instructor, whereby the criteria for choice of means may be based upon the ability of the chosen software resident in the metering mechanism to meter a particular measure and the inclusion of that measure in the preference list of the funding source,

further whereby the metering mechanism may be selected for communication of the compensation to the exercise instructor during the continuing submission of the exercise instruction class.

### Scheduled Example 2

### Literary Embodiment

In a still further embodiment of the current invention the submitter may be an author that desires to report on the attributes of a new novel published by the author. The author's goal may be to generate orders through established bookstores without a publisher. The author may have used the internet to access a web page presented by a site provider that features literary subjects. This web page may list the attributes in a submitter and an exposition sought by the site provider. The web site provider may have enlisted for funding sources a marketer of cosmetics and a retail chain as funding sources. The author may submit a lead and is assigned a favorable day and time. The web site provider may display a web page catalog of the various subjects, times, and authors that are to be featured in the near future on the site to draw viewers. The exposition of the novel may draw an audience of over five thousand viewers for the twenty-minute exposition. The preference list of the two funding source may be additive since funding source media was shown by both throughout the exposition and book review. Each viewer may earn the site provider $0.20. The site provider may supply a web address for questions to be asked of the author by the viewers on the exposition web page. Over five hundred questions may be submitted by viewers earning a price value of $2.00 each from the advertiser for this evidence of viewer attention, advertisement exposure, and viewer e-mail address capture. As the exposition nears its end, two hundred viewers may click through on the banner advertisement to the cosmetic product web page earning a price value of $0.50 each. The site provider and the author may spilt the $2,100.

Subsequent to the exposition, orders of the novel from local bookstores may exceed the number available from the first printing.

### Scheduled Example 3

### Technical Symposium

In a still further embodiment of the current invention, four scientists as submitters may arrange an exposition in the form of a panel discussion at a specific time on an advanced field of physics. The scientists may have prearranged with their professional organization to sponsor the exposition by providing a list of 2,500 e-mail addresses of current and prospective members and other interested parties and companies. The site provider may schedule the exposition and use the list for promotion purposes by sending each of the 2,500 and e-mail announcement. Due to the narrow field the site provider may only be able to enlist two advertisers of laboratory equipment from its database of marketers, and may only advertise the exposition on ten other associated sites.

The subject may only attract a few hundred fellow scientist viewers. To keep the multi-media exposition streaming to the viewer web terminals, each of the scientist viewers may have to strike a key, make a sound, or move the mouse cursor every two minutes or other period selected by the site provider. Beyond that response the scientists all actively participate with e-mail responses and questions that continue for a four-hour exposition. The exposition may be ended when the compensation numbers transmitted in real time from the web provider indicate a drop in audience. This two hour technical discussion may cost each of the two product advertisers and the professional organization $2,000. One third of the $6,000 gross income to the site provider may be earned by the scientist in compensation. The multicast may give excellent exposure for the professional organization that subsequently may sign up many new members. The product exposure of four hours to an otherwise unreachable niche market audience for the laboratory equipment marketers may only cost each marketer $2,000. The web site provider may net $4,000 for its announcement and web site multicast services.

### Scheduled Example 4

### Business to Business Exposition

In a still further embodiment of the present invention a manufacturer of electronic components may be the site provider, web host, and funding source. The submitters may be independent engineers and technicians within an industry that is scattered across multiple locations around the world. These engineers may be working with diverse applications of these electronic components beyond the knowledge of the provider. The viewers may be other engineers and technicians interested in acquiring application specific news, data, methods, training, and information. In this embodiment the host site may be offered free to the viewers without outside advertising because the manufacturer benefits by increased purchases of electronic components and therefore fulfills the roll of funding source. The future sales of the manufacturer's product may be likely to increase in proportion to the interest generated within the multicast viewers by each reporter. Thus it may be equitable that the site provider compensate each reporter for their contributions to the site based on the exposure generated in terms of number of viewers and other viewer exposure measures. The viewers may enjoy the benefit of new technical knowledge that would not be available without the submitter's compensation due to the teaching of an embodiment of this invention. Thus an equitable and beneficial financial result may be created for all parties due to the apparent attributes of an embodiment of the present invention that include initialization, metering, calculation, and real time transmission of compensation.

### Scheduled Example 5

### Performance Embodiment

In a still further scheduled embodiment of the present invention, the site provider may be a well-known musician. The provider site may have a domain name that reflects a talent search theme. Funding sources may be record companies and marketers of musical instruments that advertise on the provider site. Submitters may be independent amateur musicians and performers that have written original music unpublished and unperformed elsewhere. Hundreds of musicians may be automatically scheduled everyday by the provider site on a first-come first-served basis for premium time slots on multiple hosted channels. The viewers for this embodiment may only sample one packet of streaming exposition before moving to the next as each viewer shops for the performance that is of greatest interest.

For this reason advertisers may prefer to have their advertisements positioned similarly across multiple web pages or channels within a provider site. Also because of this page hopping by viewers, the price value for one viewer for one streaming multi-media packet of a duration may be relatively small. However, the advertiser may be assured a sufficient duration of view for comprehension for each viewer over multiple expositions. In a variation of this embodiment the site provider may at the scheduled time feature a catalog depicting multiple live expositions on a single page. From a live catalog the viewer may view many live samples before selecting the full screen version of a performance. In yet another variation of this embodiment, expositions are scheduled to perform at three different subsequent times. Viewer's preferences for expositions may be logged and registered to allow rapid selection of only those items of interest during subsequent sessions. After each performance those expositions that have earned the most compensation may advance to the next scheduled time slot. Some submitting musicians may enlist their friends and relatives to attempt to influence the metering mechanism results in their favor by loading the viewing audience for their musical exposition. By the second round of this three-round variation of this performance embodiment, the selection of thousands of viewers may easily overwhelm any possible solicited audience. By the end of the third round of performances, the best of the musicians may have received thousands of dollars of compensation and a degree of recognition otherwise impossible to achieve as an amateur.

FIG. 1 shows the independent entities of the internet news compensation system. The provider site may be the central operating entity of the internet news compensation system. The provider site may be the gatekeeper for the material that is hosted on the site. The provider site also may provide indexing, catalog hosting, tracking, metering, compensation accounting, billing, communication services, and multi-media hosting. The submitters may supply the multi-media expositions that are the basis of the products that are hosted. The viewers may select among the available products. The funding sources may provide the financial fuel for the process. Background data suppliers may be either commercial or free sites that may supply information selected to broaden the aspects of a multi-media exposition. Even though these are independent entities the teaching of an embodiment of the current invention is that the submitters, the funding sources, the viewers, the background data suppliers and the associated site suppliers all may communicate and interact in real time with the site provider as dictated by the site provider.

FIG. 2 shows that for this embodiment there may be three entities that operate within the internet environment. The process flow may start as indicated with a transmission of a lead from a submitter web terminal to the provider site. Upon receipt of the lead by the provider site the provider site may either accept or reject the lead. The criteria for acceptance or rejection may be due to the subject matter or the location of the submitter designated in the lead being incompatible with the offering goals of the provider site. For example a breaking news site would reject a human-interest subject, or a car accident in a Canadian location would be outside the audience coverage of a California site provider. With acceptance of the lead, the lead may be indexed and cataloged and a request for the multi-media exposition may be sent to the submitter web terminal. The index process may assign or use a unique designator to the exposition. The index process may also use an inherently unique designator within the lead such as a cell phone number or a web address. The submitter web terminal may respond to the approval and request for the exposition by initiation of broadband data transmission by the internet to the provider site. The provider site may receive the data comprising a multi-media exposition. Process steps shown in the dotted block number 1 may comprise the activities of the submitter web server. After receipt of the multi-media exposition, the catalog may be hosted for download, display, and item selection by viewer web terminals. The catalog host may share a direct link for continuous electronic communication with the Multi-media Expositions Host. These two process steps shown in the dotted block number 2 may comprise the activities of the viewer web server. A selection of an item by a viewer web terminal from the catalog may trigger the download and direct viewing of the selected multi-media exposition from the group of multi-media expositions hosted on the provider site. The selection and its subsequent download may initiate tracking of the multi-media exposition based upon its prior index. The viewing may then be metered based upon one or more viewer exposure measures. The metering information may be used as the basis for calculating compensation, which may be transmitted to the submitter web terminal. The process steps shown in the dotted block number 3 may comprise the activities of the computerized metering mechanism. This transmission of the compensation may end the provider site process, but the process may be iterative and may be updated continuously during the multi-media exposition transmitted by the submitter web terminal.

FIG. 3 shows product flow between the four major components comprising the provider site of an embodiment of the current invention and their internal elements. Each of the four major components may be electronically connected to and in real time communication with all other components as indicated by the four short connecting lines. The large arrows indicate the flow of the multi-media expositions. The submitter server may be comprised of web connections, leads, and multi-media expositions. The multi-media expositions may be accepted, indexed, and cataloged according to information provided in each lead. The layout web server may comprise web connections, funding source preference lists, funding source media, and background data, which may be accepted, indexed, and combined with the multi-media expositions into a layout. Background data may be requested by the submitter or supplied independently by the site provider to strengthen a weak exposition with low viewer measures, or amplify an exposition of some important event. The layout server may record the multi-media expositions into an archive. The archive may be available for sale to other media such as television. The archive may also be used by an automated gatekeeper to prevent the use in an exposition of a previously recorded exposition or copyrighted material. The layout of the funding source media on the multi-media expositions may be dictated by the preferences. The combined layout may then be transmitted to the viewer server. The viewer web server hosts a multitude of viewer web connections and a catalog for online display. The viewers may select from the multitude of multi-media expositions listed in the catalog. The five upward arrows may illustrate the viewers' selection choices. The lines intersecting the viewer arrows may indicate the interception, monitoring, and metering of the viewers by the metering mechanism. The metering mechanism may track and meter the viewers as represented by the clock illustrating the time, date, and duration of view, and the counter illustrating the number of viewers, which shows that 13,751 viewers have downloaded and observed a particular multi-media exposition. The metering mechanism may utilize metering data to calculate both submitter compensation and funding source billing in real time.

FIG. 4 shows the flow of the multi-media and media from the submitter web terminals to the viewer web terminals. The arrows with an “E” may represent the flow of the multi-media expositions through the system. The expositions may enter the system from submitter web terminals and may be uploaded to the submitter web server. The expositions may then be transmitted to the layout web server, whereby the funding source media “M” may be transmitted to the layout web server by funding source terminals. Further, background data terminals may transmit background data “D” to the layout web server. The funding source media and background data items may be matched to each multi-media exposition based on subject matter and funding source preferences, thereby forming completed layouts “L”. The completed layouts “L” may then be transmitted to the viewer web server and further to the viewer web terminals. The computerized metering mechanism may receive and transmit tracking data “T” from and to the viewer web server. The short lines may indicate the electronic connections between major elements. Although separate computer servers and mechanisms are described as components of the provider site, substantially all the servers, metering mechanisms, calculation mechanisms, and internet communication devices described within the provider site may be incorporated into a single computer web server hardware unit.

FIG. 5 shows the monetary data flow communicating submitter compensation “C” and funding source expense billing “B”. The metering mechanism may calculate submitter compensation and transmit the compensation “C” to the submitter web server, whereby the compensation “C” may be further transmitted to submitter web terminals. Additionally, the metering mechanism may calculate funding source expense billing “B” and transmit the expense billing “B” to the layout web server, whereby the expense billing “B” may be further transmitted to funding source terminals.

FIG. 6 shows the structure that may assign price values to preference categories and preference groups. Three viewer exposure measures are indicated by a double asterisk: exposure per viewer, click through, and address capture. The example is for a funding source called XYZ Windows, Inc. The preference list for this example company is listed in three columns. The funding source media item in this example may be a window advertisement. It is shown at the bottom of the spreadsheet. The funding source preference categories may be comprised of subject of the exposition, geographic coverage, time of day, layout placement of the media item on the screen, and viewer response. The preference groups for the preference categories are listed in the center column. A price value per viewer may be assigned individually by group within each preference category in the right column. For example, if the layout places the funding source media item as a marquee, the media item will scroll across the bottom of the screen during the multi-media exposition. As a funding source media item may be displayed to viewers with each preference-matched multi-media exposition, then the price value for that preference is applied for compensation calculation. In this example the Marquee layout may cost the funding source $0.05 for each metered viewer. Price values may generally be set competitively within an industry. Various auction and reverse auction methods may be used by the site provider for the establishment of preference price values with funding sources.

FIG. 7 shows an application of the cost structure for a single submitter of a single exposition. The costs shown are an instantaneous snapshot, however the exposition may be ongoing and live. Thus, for this example, the costs may be assumed to continue to accrue after this snapshot until the exposition is terminated. The submitter is identified with initials, A.J.P. The lead information submitted by the individual submitter is designated with an asterisk. The example shows the data items in the lead to be the submitter's name, web address, GPS location, credit card number, the subject of the exposition, and the coverage, in this case “Dallas Local.” The second line shows the unique exposition index number, 12,175 that has been assigned by the site provider upon approval of the lead. The calculation spreadsheet may include the date, the time the lead was approved, the current time, funding source preferences, funding source preference price values for each group, and the cumulative number of metered viewers. During the approximately fifty minute exposition 3747 viewers have, thus far, been metered. Note that the time may be current based on the continuing live transmission of the exposition. The funding source expense of $1,236.51 may be calculated based upon the viewer exposure measure of price value per metered viewer. The group price values may be based on the preferences of FIG. 6. The compensation percentage split may be predetermined by the provider base upon market conditions. In this example the split between the site provider and the individual submitter is fifty percent each or $618.26.

FIG. 8 shows an example of an instantaneous snapshot of a metering and billing calculation spreadsheet for a single funding source, XYZ Windows, Inc. Four discrete expositions indexed by their exposition index numbers for two sequential days are shown. Four preference groups from FIG. 6 for this particular funding source are applied to the four expositions. This spreadsheet shows that no viewers chose either a click though or and address capture response since these two preferences are omitted. Thus, in this case the viewer exposure measure is the cumulative number of viewers. For each exposition the billing calculation spreadsheet shows the current date and time, individual exposition index numbers, funding source preferences and price values, and number of metered viewers. The funding source expense per exposition may be calculated based upon price values per metered viewer. The total expense to the funding source may be the sum of the expenses accruing to the four expositions that exposed viewers to the funding source media. This exposure may have took the form of banner, sidebar, and marquee placements on the exposition layout. The exposure may have been constant for all four expositions. Note that the first two expositions 12,175 and 12,124 are still live and in progress, while the submitters 11,832 and 11,854 were concluded the previous day and these latter totals are complete. If all the expositions were to be completed in this instant, the spreadsheet indicates that the funding source will be billed for $4,860.59 for exposure to 12,399 total viewers (3747+2168+4794+1690).

FIG. 8 also illustrates the potential variability in earnings between the four expositions. It shows the difficulty of predicting the earning potential of a particular multi-media exposition. A fixed compensation schedule for multi-media expositions may be financially hazardous when so many viewer interest uncertainties and price value combinations coexist. These uncertainties alone are indicators for a value added structure for site providers after the teaching of an embodiment of the current invention. Residual rights to recordings of momentous events captured from multi-media expositions and stored in archive may further reinforce a value added structure for site providers.

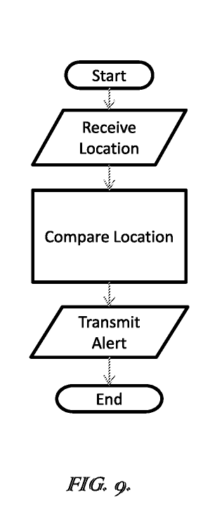

FIG. 9 is a flowchart of a method for targeting an alert of a real-time news exposition to a geographically potentially interested group of viewer web terminals according to an embodiment of the present invention. After the operation begins, an indication of a location of a submitter web terminal may be received. The receiving of an indication of the location of the submitter web terminal may include receiving either global positing system coordinates or cell phone tower triangulation information. The location of the submitter web terminal may be compared with the location of viewer web terminals to determine a geographically potentially interested group of viewer web terminals. The comparing of the location of the submitter web terminal with viewer web terminals may include comparing either viewer web terminal global positing system coordinates or viewer web terminal cell phone tower triangulation information with the location of the submitter web terminal. Alternatively, the comparing of the location of the submitter web terminal with viewer web terminals may include comparing viewer web terminal preferred locations with the location of the submitter web terminal.

The real-time news exposition may be transmitted to the geographically potentially interested group of viewer web terminals.

A priority level may be assigned to the real-time news exposition. The priority level assigned to the real-time news exposition may be compared with priority preferences of the geographically potentially interested group of viewer terminals to determine a subset of geographically potentially interested viewer web terminals. The transmitting of the real-time news exposition to the geographically potentially interested group of viewer terminals may include transmitting the real-time news exposition to the subset of geographically potentially interested viewer web terminals. The transmitting of the real-time news exposition may comprise sending an alert to the subset of geographically potentially interested viewer web terminals, receiving a view request from at least one viewer web terminal of the subset of geographically potentially interested viewer web terminals, and sending the real-time news exposition to the at least one viewer web terminal. The sending of the alert to the subset of geographically potentially interested viewer web terminals may include sending at least one of a text message, an email message, an instant message, and a social media communication. The real-time news exposition may be transmitted to contacts of the geographically potentially interested group of viewer web terminals.

### DEFINITIONS

For the purposes of the embodiments of the current invention the following definitions apply.

A web server may be a computer connected to the internet or world wide web and to other computers possessing software programs and hardware accessories that make it autonomous for continuously receiving, compiling, sorting, and transmitting digital broadband data from multiple sites. Examples are mainframe or PC computer servers. A computer may include memory for storing instructions and a processor for executing those instructions.

A submitter web server may be the gatekeeper to the provider site. It may approve or reject the lead from submitters and authorizes submittal transmission. This gatekeeper function may be reinforced with learning programs and artificial intelligence algorithms. Multi-media may comprise a combination of audio and visual images. Many computers, PDAs, and cell phones may be capable of only capturing and transmitting a series or sequence of still pictures. When accompanied by live commentary these staggered snapshots may constitute multi-media.

An independent submitter may be an individual or group who voluntarily offers to submit an exposition to a host internet site in exchange for compensation.

The term voluntary may mean without influence on an individual except for the incentive of compensation.

A web terminal may be an electronic device capable of image capture, internet multi-media transmission, internet reception, and information display. Examples of a web terminal include microprocessor driven transmission equipment and camera equipment multi-media capable such as a personal computer, laptop, palm top, PDA, internet television set-top box, camera cell phone (including a smart phone), satellite phone, digital communication camcorder, tablet device, etc.

A free agent viewer may be an individual with a multiplicity of options for internet media selection, downloading, and viewing by use of a web terminal.

A viewer web server may be a computer that is capable of transmitting multiple multi-media streams for multi-cast to multiple internet viewer web terminals.

A metering mechanism may be an autonomous software application installed and running on a web server or other internet or local area network connected computer utilized as a system component of the provider site with programmed capabilities for data tracking, monitoring, calculation, and communication.

A viewer exposure measure may be the criteria by which a provider determines the availability of a multi-media stream to a single viewer. Examples of a viewer exposure measure may comprise number of viewers, individual duration of view, average duration of view, individual viewer feedback or response, and average viewer feedback, viewer response or any combination.

Compensation may be the monetary amount awarded for an offered, accepted, submitted, and multicast exposition. Compensation may be subject to adjustment prior to payment for taxes, etc.

Payment may be the actual monetary earnings paid to an independent submitter in the form of, but not limited to, direct deposit to a bank account, a credit to a credit card account, or an electronic credit to an individual account with a service provider (cell phone account, internet account, ISP account, etc.)

Multicast may be the transmission of a single broadband data stream to multiple viewer web terminals in real time.

A site provider may be an individual, corporation, or agency, either for-profit or not-for-profit, that has planned, organized and implemented an internet site to service the general public.

A provider site may be an internet site with multiple pages and multiple multi-media streams implemented to provide news and information.

A download may be a packet or stream of data requested by and transferred to a web terminal or server from another web server or web terminal.

Indexing may mean providing a unique identity and data position within a database of similar items. Indexing may treat all associated data from an individual as an object.

Tracking may be the maintenance of identity, record of location, and record of use of a data item as it is received, transmitted, stored, and viewed through a plurality of hardware and software data processing entities.

A preference list may be the criteria stipulated by a funding source for the use of that funding source media item by the provider site. A preference list may comprise association preferences, layout preferences, and price values.

Association preferences may be the criteria for association of funding source media with an exposition and the price value for the satisfaction of those criteria. Examples of association preferences may comprise subject, location, or time of day or any combination thereof.

Layout preferences may be the criteria for layout and presentation of funding source media integral with an exposition screen and the price value for the satisfaction of those criteria.

Examples of layout preference criteria may comprise banner ads, sidebar video, and ticker tapes.

Price value may be the monetary amount offered to be paid by a funding source for the performance of a service specified in general terms by a preference, preference category, or preference group.

Although embodiments of the present invention have been shown and described, it would be appreciated by those skilled in the art that changes may be made in these embodiments without departing from the principles and spirit of the invention, the scope of which is defined in the claims and their equivalents.

1. A system for targeting an alert of a real-time news exposition to a geographically potentially interested group of viewer web terminals, comprising:
a computer server to accept the real-time news exposition submitted by from a submitter web terminal, and further to track and meter the real-time news exposition chosen for display on viewer web terminals, and further to calculate compensation based upon at least one viewer exposure measure of the real-time news exposition, and further to communicate said compensation in real-time to the submitter web terminal; and
logic configured to:
receive an indication of a location of the submitter web terminal;
compare the location of the submitter web terminal with viewer web terminals to determine the geographically potentially interested group of viewer web terminals; and
transmit the real-time news exposition to the geographically potentially interested group of viewer web terminals.

2. The system of claim 1, wherein the logic is further configured to:
assign a priority to the real-time news exposition; and
compare the priority level assigned to the real-time news exposition with priority preferences of the geographically potentially interested group of viewer terminals to determine a subset of geographically potentially interested viewer web terminals,
wherein the transmitting of the real-time news exposition to the geographically potentially interested group of viewer terminals comprises transmitting the real-time news exposition to the subset of geographically potentially interested viewer web terminals.

3. The system of claim 2, wherein the transmitting of the real-time news exposition to the subset of geographically potentially interested viewer web terminals comprises:
sending an alert to the subset of geographically potentially interested viewer web terminals;
receiving a view request from at least one viewer web terminal of the subset of geographically potentially interested viewer web terminals; and
sending the real-time news exposition to the at least one viewer web terminal.

4. The system of claim 3, wherein the sending of the alert to the subset of geographically potentially interested viewer web terminals comprises sending at least one of a text message, an email message, an instant message, and a social media communication.

5. The system of claim 1, wherein the receiving of an indication of the location of the submitter web terminal includes receiving either global positing system coordinates or cell phone tower triangulation information.

6. The system of claim 1, wherein the comparing of the location of the submitter web terminal with viewer web terminals includes comparing either viewer web terminal global positing system coordinates or viewer web terminal cell phone tower triangulation information with the location of the submitter web terminal.

7. The system of claim 1, wherein the comparing of the location of the submitter web terminal with viewer web terminals includes comparing viewer web terminal preferred locations with the location of the submitter web terminal.

8. The system of claim 1, wherein the submitter web terminal comprises a cell phone.

9. The system of claim 1, wherein at least one viewer web terminal comprises a cell phone.

10. The system of claim 1, wherein the logic is further configured to transmit the real-time news exposition to contacts of the geographically potentially interested group of viewer web terminals.
